(19) United States
(12) Patent Application Publication
(10) Pub. No.: US 2005/0172562 A1
(43) Pub. Date: Aug. 11, 2005

(54) Door module for motor vehicles comprising a window regulator with lever

(75) Inventors: Francisco Javier Martinez Moral, Burgos (ES); Jose Ignacio Gonzalez Saiz, Burgos (ES)

Correspondence Address: BROWDY AND NEIMARK, P.L.L.C.;624 NINTH STREET, NW, SUITE 300, WASHINGTON, DC, 20001-5303, US

(73) Assignee: Gruopo Antolin-Ingenieria, S.A., Burgos (ES)

(21) Appl. No.: 10/506,191

(22) PCT Filed: May 14, 2002
(86) PCT No.: PCT/ES02/00229

(30) Foreign Application Priority Data
Mar. 11, 2002 (ES) P200200566

(51) Int. Cl. E05F 11/44

(52) U.S. Cl. 49/350

(57) ABSTRACT

Door module for vehicles, particularly incorporating an arm-type window winder unit, that consists of an assembly formed by the panel (1) and the support (8) that supports the window winder unit, and that also makes it possible to incorporate all the components capable of being assembled in the door shell with the exception of the window glass, so that later either the entire assembly is capable of being removed or otherwise the part connected to the panel, independently of the mechanical elements directly fixed onto the door, all while at the same time respecting the structural integrity of the door. One or more turrets, which form part of the panel itself, are situated between the panel and the support, and enable the fast assembly and removal of the panel, with the possibility of leaving the window winder unit connected to the door shell.

### DESCRIPTION

This invention relates to a door module for automobiles equipped with a integrated arm-type window winder, within the scope of application of modular systems for doors in which any kind of the mechanical and electrical assemblies that can go inside a door can be integrated, and particularly in the door trim itself, and more specifically to systems that include window winder systems of the so called arm-type, while always respecting the structural integrity of the door.

This door module can include a large amount of items such as: window winder unit, lock, mechanical opening system, wiring, electrical controls, control electronics, loudspeakers, safety and energy absorption systems, waterproofing elements, ventilation ducts, brightwork, etc.

At present, as far as is known, there are different systems to integrate vehicle door components into one single modular unit.

There are, for instance, metallic or plastic based door subassemblies (door cassettes) that can include the door mechanisms, for example the window winder unit, lock, wiring, loudspeaker and waterproofing Other structures are also known with an outer frame, which can include the outer frame of the door, the window glass, the rear view mirror and the window winder unit, which on occasions might include an internal substructure to strengthen the door.

Other systems, known as “support panels”, which might include the door mechanisms, window winder unit and lock, the wiring, loudspeaker and waterproofing, energy absorption elements, as well as the panel with all its accessories, handles, knobs, brightwork, pockets, drive systems, lights, etc.

Among these so called support panels, a comprehensive advanced solution is known through WO-A-00/23294 in favour of the applicant, as it allows the integration of a greater number of components and especially the door panel itself.

None of these known techniques are designed to enable the door panel and an arm-type window winder unit to be integrated into the same system, and at the same time respect the structural integrity of the vehicle door and, moreover, they do not allow the door panel to be removed independently while leaving the mechanical systems, window winder unit and lock fixed in the door in their operating position.

On this matter, we must indicate here that there are solutions which do allow the removal of the panel, although they are not so complete and do not include the panel as a constituent part of the modular unit, or which otherwise, in order to achieve them, require a series of modifications to be introduce in the door structure that affect key aspects of the automobile, such as the safety, design line, structural stability, acoustics or its constructive feasibility.

Another disadvantage of these techniques lies in the fact that the assembly kinematics is generally complex, because although it is carried out in one single operation, the positioning of the mechanisms and access to them is not totally visible to the operator, which means that their correct assembly depends to a great extent on the skill of this operator.

On the other hand, a large opening is required in the door shell in order to allow the insertion of the mechanisms during the assembly operation, which limits not only its design but also its very structural function.

The fundamental object of the present invention is to provide a door module to be fitted into a vehicle door with an integrating panel that includes an arm-type window winder unit.

Another object of the invention is to provide an integrating panel that includes an arm-type window winder unit, enables the bolting and fixing of the said arm-type window winder unit from the visible side during the assembly operation of the internal sheet steel of the door shell.

Another object of the invention is to provide a door module in which the support function is shared between the structure of the arm-type window winder unit and the door panel, allowing the functionality and integrity of the modular assembly to be conserved throughout all the handling operations from its leaving the production line until its final assembly onto the vehicle door.

Another object of the invention is to provide a door module that enable the use of a small way of access to the door shell with respect to the design of the door structure.

This singularity is very important because there are some solutions on the market which, in view of their configuration, require some structural parts of the door to be eliminated in order to improve accessibility during assembly, thus considerably weakening the door structure and therefor needing to include internal reinforcements inside the module itself in order to be able to comply with the different specifications.

In this solution, the door has a structure comparable to that of a traditional door, without needing to add other later elements supported by the door module, nor to eliminate key parts from either its structure or its style line.

In order to put these objectives into practice, the invention starts from an internal trim panel that includes several items pre-assembled onto it, among which a single or double arm-type window winder stands out, while it can also support other items such as the lock, door opening system, wiring, control electronics, audio systems, passive safety, etc.

The internal trim panel has an outer side which remains visible towards the passenger compartment of the vehicle and another inner side oriented towards the door shell. The panel has a small opening, through which there is access towards the door shell and on its inner side it is equipped with a set of legs created in the panel itself so that it can be situated and fixed to the door shell.

In the proximity of the opening, the inner side of the panel has at least one protuberance by way of a turret with a hollow interior and open on its larger side close to the outer side of the panel. This protuberance, at least, is an element claimed by the present invention.

The arm-type window winder unit, for example the double arm unit, is previously assembled onto a support base that counts on the two articulated arms, the toothed sector, an upper bar connected to the two arms with two clips to receive the window glass, the handle for opening the door and the lock.

The support base has a elongated slot, along which the lock with the handle can move from an assembly position to a working position, some holes for it to be fixed to certain points of the door shell and at least one area onto which at least one of the turrets from the panel can be fixed.

When the window winder unit is assembled onto the support base, the support base can then be situated onto the inner side of the panel, with the said support base being supported on at least one of the turrets protruding from the panel.

After this, the support base can then be fixed by means of bolts to the panel through at least one of the turrets.

In its preferred form, the turret is conical and its internal part also forms an also conical hollow space, so that it facilitates and perfectly guides the entry and extraction of the assembly bolts.

When the door module is thus fitted with the support containing the arm-type window winder unit, it is presented against the door shell in order to fit the assembled unit, by securing first the panel fixing points and then proceeding to assemble the other components included in the unit.

In order to assemble the panel, the coupling legs are inserted into 5 the corresponding holes in the internal sheet steel of the door. Then, through the opening in the panel and in a way which is visible, the operator proceeds to position and screw the window winder unit support onto the appropriate areas of the door shell.

Once the window winder unit and panel assembly is fitted, and if wishing to remove this unit, proceed to loosen and withdraw the bolts that fix the support to the door shell, and if it is necessary to change only the panel, leaving the window winder unit connected to the door shell, the bolts housed in the turret are the ones which are removed from the outer side of the panel.

Given the preferred conical shape of the hollow inside the turret, the extraction of the connecting bolt from the support is carried out easily, preventing the bolt from falling inside the door shell.

The lock and the window winder unit handle are arranged in an elongated slot in the support base in such a way that two positions are permitted, one assembly position with the lock and handle towards the most inner part of the slot and another operating position with both components at the most outer end of the slot in the final position for use. This method of operation was already described with application WO-A-00/23294.

The support part connected to the turret and including the arm-type window winder unit can have any kind of surface shape, with the ends of the hollow turret(s) adapting to this shape, so that the said support remains in an operating position when the panel is assembled in the door shell.

Therefore, when there are two or more turrets, they can be of different lengths in order to adapt to the different distances between the surface of the support and the assembly area of the door, so that this remains in its operating position.

All the details of the invention can be appreciated on the accompanying sheets of drawings, on which the following are represented:

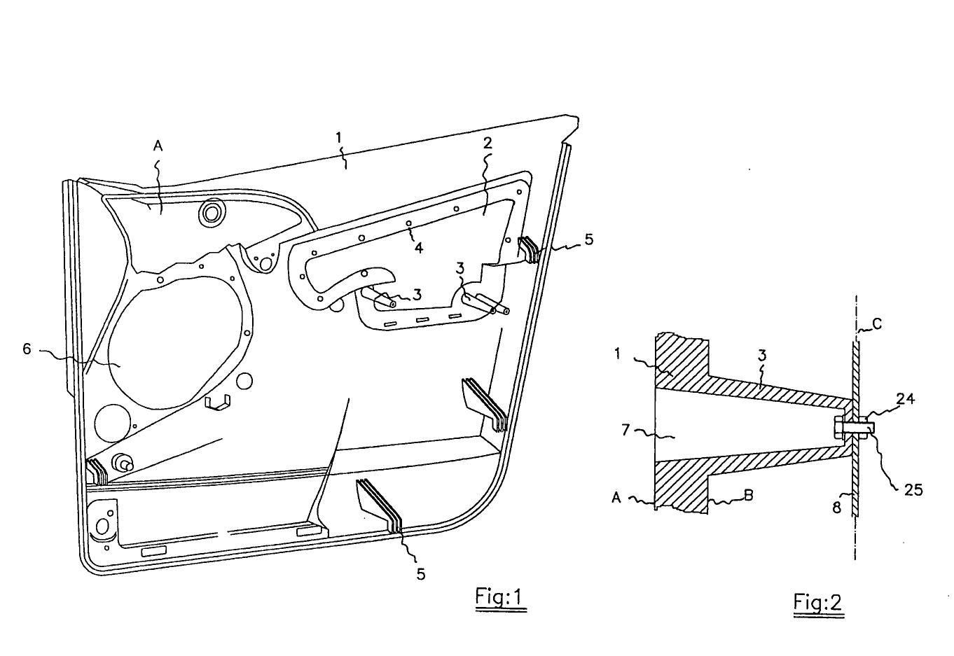

FIG. 1 is a perspective view of the panel in accordance with the invention, seen on the inner side that faces the door shell, respectively.

FIG. 2 is a vertical cross section of a turret to fit the support to the panel.

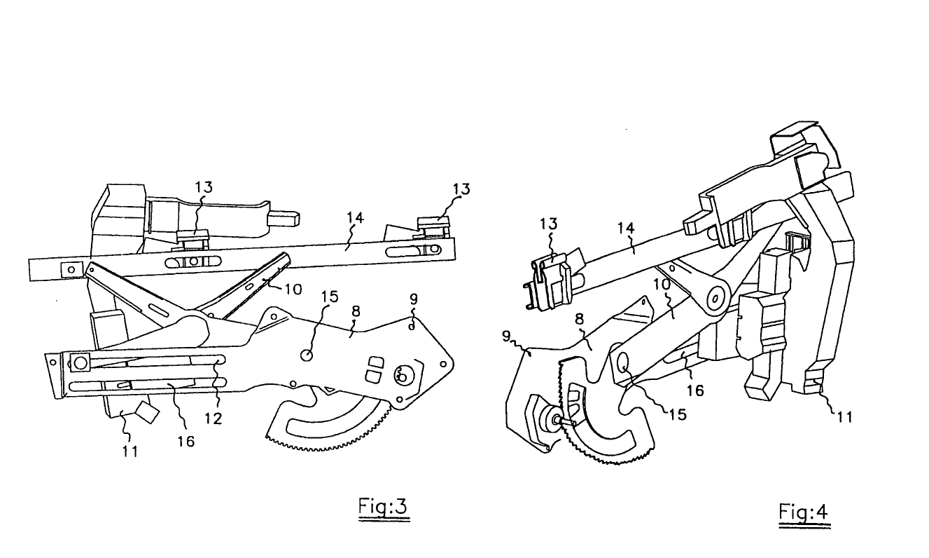

FIGS. 3 and 4 represent two perspective views of the arm-type window winder unit, seen from the panel or from the door shell, respectively.

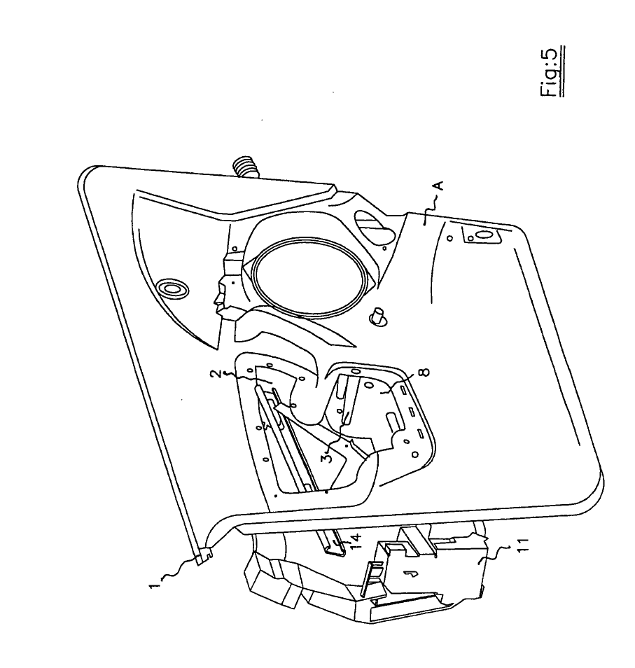

FIG. 5 is a perspective view of the complete module from the outer side of the panel.

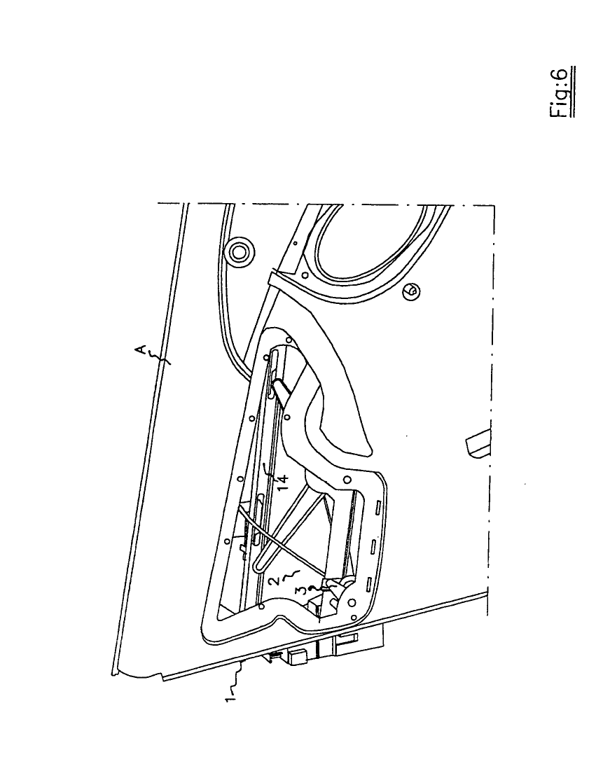

FIG. 6 is another different perspective view of the complete module, also from the outer side of the panel.

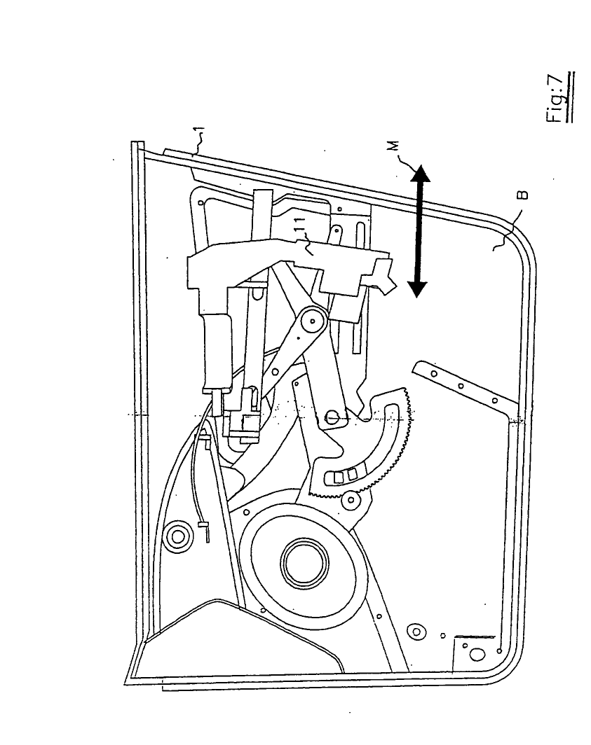

FIG. 7 represents a view of the panel—window winder unit assembly from the inner side of the panel, with the lock and handle in the provisional assembly position.

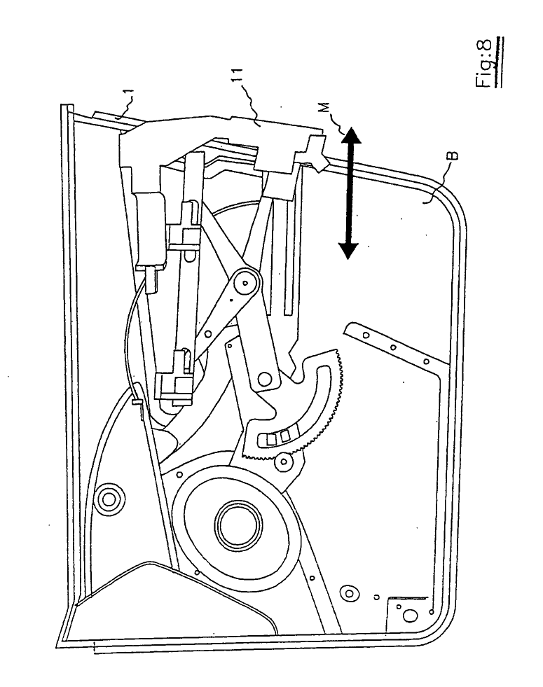

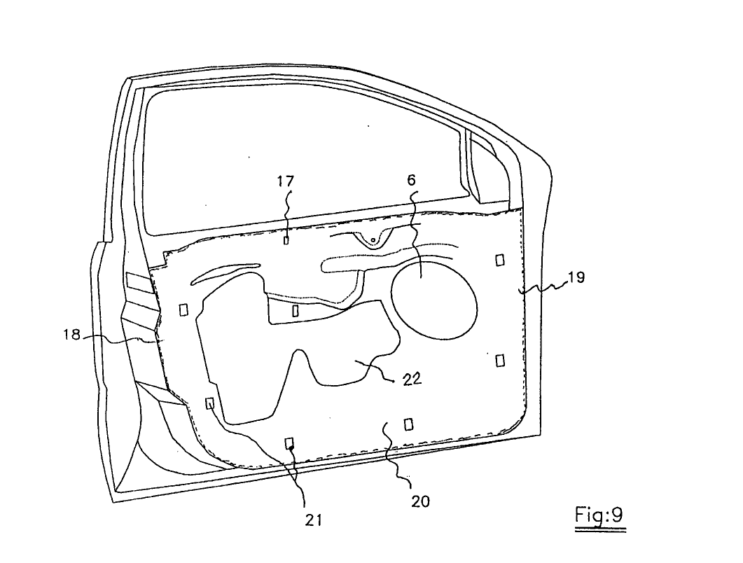

FIG. 8 also represents a view of the panel—window winder unit assembly from the inner side of the panel, with the lock and handle in their final position for use on the door.

FIG. 9 shows the design of the inner side of the door that completes the system.

Looking now at FIG. 1, we can appreciate the panel (1) with its inner side (A) towards the door shell, which is equipped with a set of hooks (5) for hanging and previous positioning in the said door shell, as well as several ribs and cavities (6) for situating other elements, for example a loudspeaker.

Prominent in this FIG. 1 is the small opening (2) that enables access for tools towards the door shell, with the holes (4) which, after assembly of the panel, will be used for fixing the boss that closes off the said opening.

In the proximity of the opening (2) it is possible to appreciate the conical turrets (3) responsible for fixing the support part on which the arm-type window winder unit is assembled to the door panel. The number of turrets is variable, although it is pointed out once again that at least one of them is necessary in accordance with the concept of the invention.

The vertical longitudinal cross section of the turrets (3) is illustrated in FIG. 2, with their preferable conical shape, that provides an internal cavity (7). These turrets open out at the outer side (A) of the panel to surpass the inner side (B), extending for a distance that culminates at a rear plane (C), which will be occupied by the support (8) that receives the arm-type window winder unit in this case.

In the same FIG. 2 we can observe the holed closure at the end of the conical turret in order to allow the bolt (25) to pass, connected in this case to the nut (24) fixed to the support (8) to prevent it from falling when the bolt is extracted.

In accordance with FIGS. 3 and 4, we can observe the arm-type window winder unit with its arms (10) connected in an articulated manner to the profile (14) that holds the elements (13) for connection to the window glass: clipping or bolting drive slide clips, etc., not illustrated. This window winder unit is fixed to the support part (8) through the articulation (15), which has a slot (12) in which the end of one of the arms of the window winder unit (10) can move.

The support has another slot (16) on which it is secured during the transport and assembly of the module and on which the lock (11) connected to the operating handle (13) can move.

The support (8) has several holes (9) so that this assembly can be fixed to the points determined in the door shell, and access can be gained to these through the opening (2) in the panel.

In accordance with FIGS. 5 and 6, it is possible to appreciate the visible outer side (A) of the panel (1) and, behind this, the window winder unit seen through the opening (2), as well as the end of the lock (11) and handle. The turrets (3) represented here are connected to the support (8), so that a stable unit is formed, which is fixed to the door shell, with access to the fixing points being gained through the opening (2), and by means of bolts hat pass through the holes (9) in the said support (8).

Once this operation has been carried out, the opening (2) is then covered with the corresponding boss, either independent or hinged to the panel itself, exactly as defined in WO-A-00/23294.

In accordance with FIGS. 7 and 8, we can observe the inner side of the assembly of the panel (1)—window winder unit, in a unit prepared for fixing to the door shell. In FIG. 7, the lock is in its assembly position, whereas in FIG. 8 the lock has moved along the slot in the support as indicated by (M) to what will be its final location once assembled on the door.

In the unit in the invention, it has been found that with at least one single conical turret (3), sufficient fixing is created between the panel (1) and the support (8). Nevertheless, the possibility also enters into the invention of counting on more than one turret, all according to requirements.

The turret, or the turrets, stand out in the proximity of the opening (2) and will preferably be made of the same material as the panel.

At least one turret can possibly be formed by another independent body and connected to the panel, which allows access to its interior through the outer side (A) of this panel.

In some cases, a turret might have an interior shape which is not conical, although it is pointed out here for the appropriate purposes that this conical solution is the one preferred in accordance with the invention.

In FIG. 9, the inner side of the door makes it possible to observe that not only the upper reinforcements (17) in the area of the door window weatherstrip but also the forward and rear reinforcements (19, 18) of the areas close to the hinges and lock are maintained inside the door structure. This configuration enables a structural response in accordance with the regulations in force without needing to add any supplementary reinforcement supported by the modular assembly.

In this same FIG. 9, we can also observe the cavity (6) for the loudspeaker, the opening (22) for the assembly of the window winder unit and the various holes (21) for the coupling of the panel, all of which is carried out in the internal sheet steel (19) of the door that closes off the door shell and on which the panel of the module is mounted.

1. Door module for automobiles, with an arm-type window winder unit, that has a panel (1) with an outer side (A) towards the passenger 5 compartment and an inner side (B) towards the door shell, a support (8) for a window winder unit connected to the panel and for fixing to the door shell, while also counting on an opening (2) made in the panel for the assembly of the support (8) to the said door shell, which is characterised in that it allows the joint assembly of all the elements that are incorporated into the door, with the exception of the window glass and the door itself, and later allows, when required, the removal either of the complete unit or otherwise only the door panel, independently, and its related components, while leaving the rest of the mechanical components, arm-type window winder unit, lock and window winder drive system fitted onto the door, respecting the structural integrity of the door itself.

2. Door module for automobiles, with an arm-type window winder unit, in accordance with claim 1, characterised in that it makes it possible to establish and give access to the fixing systems for all the elements that need a solid connection to the door, thanks to the access provided through the door panel.

3. Door module for automobiles, with an arm-type window winder unit, in accordance with claim 1, characterised in that it includes:
at least one hollow turret (3) that protrudes from the inner side (B) of the panel (1), whose interior is reached from the outer side (A) of the panel, with the turret in the proximity of the opening (2) standing out,
an arm-type window winder unit (10, 13, 14) mounted on a support (8), which in turn is connected to the free end of the at least one turret (3) by means of a bolt coming from the outer side (A) of the panel, and with the support having holes (9) for it to be fixed to the door shell,
the support (8) connected in this way to the panel (1) by the at least one hollow turret (3) remains in its operating position when the said panel is assembled in the door shell.

4. Door module for automobiles, with an arm-type window winder unit, in accordance with claim 3, characterised in that at least one hollow turret (3) has a conical shaped internal cavity (7), with its larger end towards the outer side (B) of the panel.

5. Door module for automobiles, with an arm-type window winder unit, in accordance with claim 3, characterised in that the at least one hollow turret (3) is made out of the same material as the panel (1) and created from this panel.

6. Door module for automobiles, with an arm-type window winder unit, in accordance with claim 3, characterised in that the at least one hollow turret (3) is made independently of the panel (1).

7. Door module for automobiles, with an arm-type window winder unit, in accordance with claim 3, characterised in that more than one hollow turret (3) is provided, with each one protruding appropriately until their connection with the support (8), so that the support remains in its operating position in relation to the door shell.

8. Door module for automobiles, with an arm-type window winder unit, in accordance with claims 1 and 2, characterised by the absence of structural reinforcing parts in order to pass the structural and safety specifications of modern vehicles.

9. Automobile door with a suitable configuration to be able to hold a door module in accordance with claims 1 and 2, characterised in that it enables the assembly and removal of the module while the door shell maintains not only its upper but also its forward and rear structural reinforcements in such a away that it can pass all the current safety regulations without needing to add any structural supplement.

10. Door module in accordance with claims 1, 2 and 3, characterised by being able to incorporate all the mechanical elements connected in the same assembly unit, ready to fulfil all their functions once the unit is mounted on the vehicle door and to be able to check the condition of the 5 elements before their assembly into the vehicle.

11. Door module in accordance with claims 1, 2 and 3, characterised by being able to incorporate all the electrical elements interconnected in the same assembly unit, ready to be able to fulfil all their use functions and to be able to check the condition of the elements before their assembly into the vehicle.
